(19) United States
(12) Patent Application Publication
(10) Pub. No.: US 2023/0278443 A1
(43) Pub. Date: Sep. 7, 2023

(54) SYSTEM FOR USE IN DOCKING AND CHARGING MICRO-MOBILITY ELECTRIC VEHICLES

(71) Applicant: Kuhmute Inc., Almont, MI (US)

(72) Inventors: Peter Mark Deppe, Almont, MI (US); Melody Denby, Flint, MI (US); Jared Robinson, Swartz Creek, MI (US)

(21) Appl. No.: 18/088,457

(22) Filed: Dec. 23, 2022

Related U.S. Application Data
(60) Provisional application No. 63/293,307, filed on Dec. 23, 2021.

(51) Int. Cl. B60L 53/31; B60L 53/14; G06K 7/10

(52) U.S. Cl. CPC B60L 53/31; B60L 53/14; G06K 7/10297; B60L 2200/24

(57) ABSTRACT

A system for docking and charging micro-mobility electric vehicles is provided. The system may be used for docking and charging a plurality of micro-mobility electric vehicles. The system includes a vehicle coupling mechanism and a hub. The vehicle coupling mechanism is associated with a vehicle and includes a docking member. The hub includes a station comprising a hub coupling mechanism and a hub component assembly. The hub coupling mechanism includes a receptacle for receiving the docking member. The hub component assembly comprises a locking assembly, charging plungers, and induction sensors. When the receptacle receives the docking member, the charging plungers are moved towards the induction sensors, the locking assembly locks the vehicle in place, and the induction sensors sense a vehicle locked in the station and activate the hub to begin charging the vehicle.

### CROSS-REFERENCE TO RELATED APPLICATIONS

This application claims priority to U.S. Provisional Application 63/293,307, entitled “SYSTEM FOR USE IN DOCKING AND CHARGING MICRO-MOBILITY ELECTRIC VEHICLES”, filed Dec. 23, 2021.

### BACKGROUND

Micro-mobility electric vehicles, such as electric bicycles, electric scooters, electric wheelchairs, electric skateboards, and the like, are an increasingly popular mode of personal transportation in urban and other environments. Conventional micro-mobility electric vehicles are battery powered, and provide advantages of reducing automobile traffic, decreasing air/noise pollution, increasing energy efficiency, and providing a socially-distant alternative to public transportation. While micro-mobility electric vehicles are available for private ownership, many micro-mobility electric vehicles are part of fleets that are available for short-term rental, or may otherwise be available for public use.

While micro-mobility electric vehicles provide a number of different advantages, their utilization also presents various challenges for owners, fleet operators, and municipalities in which micro-mobility electric vehicles are utilized. For example, charging the batteries of micro-mobility electric vehicles can present significant logistical challenges. Most micro-mobility vehicles may be charged using typical alternating current (AC) to direct current (DC) chargers that plug into conventional AC wall outlets. When utilized in connection with a fleet system, micro-mobility electric vehicles may be located in various locations (e.g., across a city), and may need to have the option to be charged in different locations—such as when a micro-mobility vehicle is picked up from one location and returned to another location. With relatively large fleets, it can become difficult to track the location, condition, status, and/or availability of each fleet-operated micro-mobility electric vehicle. Furthermore, theft is also a concern, particularly when vehicles are left unattended at a charging station.

When utilized as a privately-owned micro-mobility electric vehicle, additional challenges may be presented. Conventional AC wall outlets are often not widely available in desirable public locations where an owner may want to leave their micro-mobility electric vehicle for charging. Owners may be required to transport their own AC to DC charger, which could likewise be stolen if left unattended. Moreover, charging stations may be brand specific and may only be compatible with a particular brand, or a limited number of brands, of micro-mobility electric vehicles. Even if not brand specific, charging stations may have certain charging parameters, interfaces, and the like, and may only be compatible with micro-mobility electric vehicles of a certain type.

Additionally, micro-mobility vehicles themselves can present a significant source of clutter to a municipality. Many fleet operators allow vehicles to be scattered across city streets without meaningful storage options. For example, micro-mobility electric vehicle users may leave vehicles piled-up at popular destinations where there are no orderly storage options, leading to physical and aesthetic clutter.

Accordingly, there remains a need in the art for overcoming one or more of the aforementioned challenges.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

A system for charging electric vehicles, such as micro-mobility electric vehicles, is disclosed. The system includes a vehicle coupling mechanism and a hub. The vehicle coupling mechanism is associated with a vehicle and includes a docking member. The hub includes a main tube and a station. The station comprises a hub coupling mechanism and a hub component assembly. The hub coupling mechanism includes a receptacle for receiving the docking member, the coupling mechanism being provided on the main tube and being accessible by a user. The hub component assembly comprises a locking assembly, charging plungers, and induction sensors. When the receptacle receives the docking member, the charging plungers are moved towards the induction sensors, the locking assembly locks the vehicle in place, and the induction sensors sense a vehicle locked in the station and activate the hub to begin charging the vehicle. In some embodiments, the at least one receptacle is a slot and the at least one docking mechanism is a tang. The station may include a control panel associated therewith, wherein the control panel includes a push button for unlocking the station, a port identification number, and a status light ring, wherein the status light ring provides a visual indication of a status of the station.

In some embodiments, the hub component assembly may further comprise a port assembly, wherein the port assembly includes a port controller board and a low power board. The port controller board may include 36v power supply and the low power board may include a variable power supply.

In some embodiments, when the induction sensors sense a vehicle locked in the station, the induction sensors start a charging authentication process and activate the hub to being charging the vehicle upon a positive authentication process. The vehicle coupling mechanism may include a having an identification number associated therewith and the charging authentication process may involve scanning the tag.

The locking assembly may include a solenoid lock body and a locking lug wherein insertion of the docking member into the receptacle moves the locking lug towards the induction sensor. The station nay include a light source for illuminating a portion of the at least one receptacle.

In a further embodiment, a system for charging electric vehicles is provided including at least two stations. The system includes a vehicle coupling mechanism and a hub. The vehicle coupling mechanism is associated with a vehicle and includes a docking member. The hub includes a main tube and at least two stations. Each station comprises a hub coupling mechanism and a hub component assembly. The hub coupling mechanism includes a receptacle for receiving the docking member, the coupling mechanism being provided on the main tube and being accessible by a user. The hub component assembly comprises a locking assembly, charging plungers, and induction sensors. When the receptacle receives the docking member, the charging plungers are moved towards the induction sensors, the locking assembly locks the vehicle in place, and the induction sensors sense a vehicle locked in the station and activate the hub to begin charging the vehicle. In some embodiments, the at least one receptacle is a slot and the at least one docking mechanism is a tang. The hub component assembly further comprises a port controller board for providing power to the station. The hub may further a single low power board associated with all of the at least two stations for powering auxiliary components. The port controller board may include 36v power supply and the low power board may include a variable power supply. The station may include a control panel associated therewith, wherein the control panel includes a push button for unlocking the station, a port identification number, and a status light ring, wherein the status light ring provides a visual indication of a status of the station.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

In the following figures like reference numerals are used to identify identical components in the various views. The present disclosure will become more fully understood from the detailed description and the accompanying drawings.

FIG. 1 illustrates a perspective view of a system for docking and charging electric vehicles, shown with three different types of vehicles docked to a hub, in accordance with one embodiment.

FIG. 2 illustrates an electric vehicle having an adapter for docking and charging the electric vehicle as coupled to such vehicle, in accordance with one embodiment.

FIG. 3A illustrates a perspective view of a hub, shown having receivers for docking with and charging electric vehicles, in accordance with a first embodiment.

FIG. 3B illustrates a perspective view of a hub, shown having receivers for docking with and charging electric vehicles, in accordance with a second embodiment.

FIGS. 4A-4D depict a sequence of an electric vehicle having an adapter approaching and engaging a receiver of a hub to dock the electric vehicle to the hub and charge the electric vehicle, in accordance with one embodiment.

FIG. 5 illustrates a perspective view of a receiver on a hub, in accordance with a first embodiment.

FIG. 6A illustrates a front view of a receiver on a hub, in accordance with a second embodiment.

FIG. 6B illustrates a front perspective view of a receiver and control pane on a hub, in accordance with a second embodiment.

FIG. 6C illustrates a front perspective view of a receiver and control pane on a hub, in accordance with a second embodiment.

FIG. 7A illustrates a front view of a receiver, in accordance with a first embodiment.

FIG. 7B illustrates a front inside view of a receiver, in accordance with a first embodiment.

FIG. 8 illustrates a perspective inside view of a hub with a receiver installed therein, in accordance with a first embodiment.

FIG. 9 illustrates a front perspective view of a receiver including an upper and lower portion depicted in phantom to reveal locking assemblies, in accordance with a first embodiment.

FIGS. 10A-10C illustrate a sequence of an adapter engaging a hub to charge an electric vehicle and retain the adapter relative to the hub, in accordance with a first embodiment.

FIG. 11 illustrates a front view of a receiver on a hub, in accordance with a second embodiment.

FIG. 12 illustrates a top view of a receiver and hub component assembly, in accordance with a second embodiment.

FIG. 13A illustrates a hub component assembly with a receiver attached thereto, in accordance with a second embodiment.

FIG. 13B illustrates the hub component assembly of FIG. 13A without the receiver.

FIG. 14A illustrates a front view of hub component assembly without the receiver attached, in accordance with a second embodiment.

FIG. 14B illustrates the hub component assembly of FIG. 14A with the receiver attached.

FIG. 15A illustrates a rear view of a hub component assembly first port in a tube, in accordance with a second embodiment.

FIG. 15B illustrates a rear view of a hub component assembly with a second port in a tube, in accordance with a second embodiment.

FIGS. 16A-16D illustrate a hub component assembly inside a main tube of a hub, in accordance with a second embodiment.

FIG. 17 illustrates a high level hub component diagram, in accordance with one embodiment.

FIG. 18 illustrates a diagram of the port assembly, in accordance with one embodiment.

FIG. 19 illustrates a process flow of a variable charging selection process, in accordance with one embodiment.

### DETAILED DESCRIPTION

A system for docking and charging micro-mobility electric vehicles is provided. The system may be used for docking and charging one or more micro-mobility electric vehicles. Moreover, the system may be used for docking and charging a plurality of types of micro-mobility electric vehicles.

A system for docking and charging micro-mobility electric vehicles is provided. The system includes a vehicle coupling mechanism and a hub. The vehicle coupling mechanism is associated with a vehicle and includes a docking member. The hub includes a station comprising a hub coupling mechanism and a hub component assembly. The hub coupling mechanism includes a receptacle for receiving the docking member. The hub component assembly comprises a locking assembly, charging plungers, and induction sensors. When the receptacle receives the docking member, the charging plungers are moved towards the induction sensors, the locking assembly locks the vehicle in place, and the induction sensors sense a vehicle locked in the station and activate the hub to begin charging the vehicle.

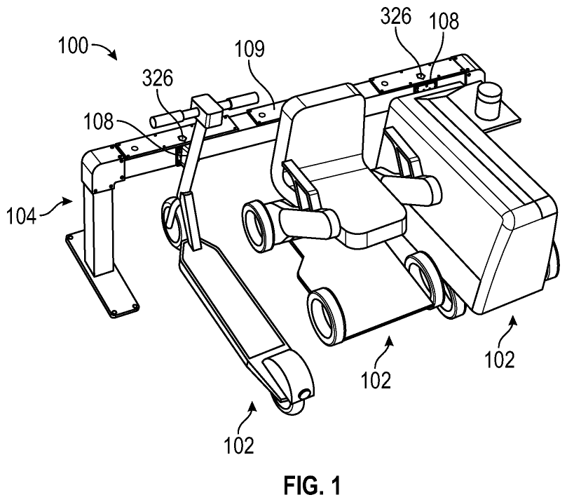

FIG. 1 illustrates a system 100 for docking and charging various types of micro-mobility electric vehicles 102. The system shown in FIG. 1 is intended to illustrate generic components of the system and details specific to various embodiments will be detailed below. As shown, the system 100 generally includes a hub 104 with a main tube 109. One or more receivers 106 are provided along the main tube configured to releasably dock and retain an adapter 108 secured to a respective electric vehicle 102. Each receiver defines a port of a charging station. The representative embodiment of the hub 104 illustrated in FIG. 1 includes three receivers 106, but other quantities and/or arrangements of receivers 106 are within the scope of the present disclosure. The system may be used with a plurality of electric vehicles as well as with a plurality of types of electric vehicles.

As described in PCT/US2020/042973, entitled “System For Use In Docking and Charging Micro-Mobility Electric Vehicles”, filed on Jul. 22, 2020, which is hereby incorporated by reference, the system 100 is configured for use in docking electric vehicles 102 and for charging batteries of electric vehicles 102 via a power source via engagement occurring between the receiver 106 of the hub 104 and the adapter 108 secured to the electric vehicle 102. Notably, the system 100 is configured for charging different types of electric vehicles 102 (e.g., an electric bicycle, an electric scooter, an electric wheelchair, an electric skateboard, an autonomous delivery robot, and the like), and can facilitate charging different types of batteries.

The receiver on the hub and the adapter, for mounting on the electric vehicle, are configured to engage such that power may be drawn from the hub to the electric vehicle. While a male-female engagement, with the adapter being male and the receiver being female, is shown, this is merely an illustrative embodiment. It is to be appreciated that the receiver and adapter may engage in any manner and, if a male-female connector is employed, the receiver may alternatively be a male connector and the adapter a female connector. The receiver and adapter may alternatively be referred to as a hub coupling mechanism and a vehicle coupling mechanism respectively.

The system for docking and charging micro-mobility electric vehicles and the hubs and adapters for such charging may be provided as part of a charging network for micromobility. In some embodiments, shared or rentable electric vehicles may be associated with the charging network. The shared or rentable electric vehicle may be unlocked from one station, used, and then returned to that station or a different station, where it is again locked and available for rental.

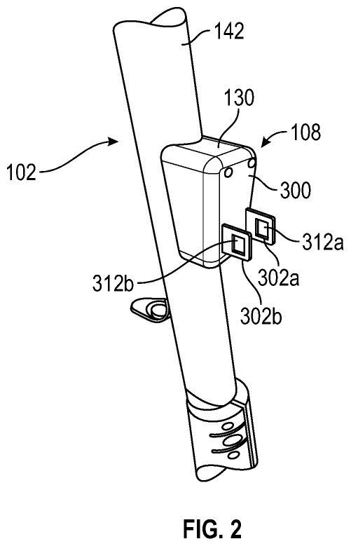

FIG. 2 illustrates an adapter, or vehicle coupling mechanism, in accordance with a first embodiment. The adapter may be integrally built with, may be attached to, or may otherwise mounted on, an electric vehicle. The adapter 108 may include a housing 130 that is secured to the electric vehicle 102. Attachment and/or securing of the adapter to the electric vehicle may be achieved in any suitable manner depending on the specific configuration of the electric vehicle 102. In the embodiment illustrated in FIG. 2, for example, the electric vehicle 102 is an electric scooter having an elongated steering column 142 with a generally circular profile. The adapter 108 may be configured to be removably attached to the elongated steering column 142 using any suitable attachment means. In general, the adapter includes an adapter assembly comprising a front cover, docking members, and standard electrical assembly for charging an electric vehicle. The adapter assembly may be incorporated into a housing having any suitable shape for interfacing with an electric vehicle.

In some embodiments, one or more portions of the vehicle coupling mechanism 108 may be integrated into the electric vehicle 102 during manufacture of the electric vehicle 102. However, it is also contemplated that adapters 108 may be secured to pre-manufactured electric vehicles 102 as an aftermarket option, accessory, module, and the like.

In some embodiments, each vehicle coupling mechanism may have an associated identification number or ID that may be used with the charging system and for communication within the charging network for micromobility and specifically with the charging app. Each adapter may further include an NFC (near field communication) tag, RFID (radio-frequency identification) tag, or similar technology to transmit vehicle charging details or a vehicle profile to the hub.

In some embodiments, when a user installs an adapter on their electric vehicle, the user may set up the vehicle on a charging app associate with the charging network for micromobility. This may include any of creating a profile, registering the adapter ID with the charging network for micromobility, linking the adapter ID to the charging app, choosing a primary location for population of a map with charging stations, inputting billing information, and the like.

In the embodiment shown, the adapter 108 includes a front cover 300, a first docking member 302a and a second docking member 302b. The docking members are configured for engagement with the receiver or hub coupling mechanism. While two docking members are shown, a single docking member or more than two docking members may be used. The docking members 302a and 302b extend from the front cover 300 of the adapter 108. More specifically, the first and second docking members 302a, 302b may extend from the adapter 108 to engage the receiver 106 to releasably dock and retain the electric vehicle 102 relative to the hub 104 and to charge the electric vehicle 102.

The docking members conduct material from the hub to the electric vehicle. Accordingly, the docking members may be comprised of a conductive material, such as a metal. In some embodiments, the docking members may have a bent profile to facilitate engagement of the first and second docking members with the internal circuitry of the adapter 108 to facilitate charging of the battery of the electric vehicle 102. In general, any suitable shape of docking member may be used that is complementary with receptacles of the receiver (described below).

In the embodiment shown FIG. 2, the first docking member 302a defines a first catch 312a. Similarly, the second docking member 302b defines a second catch 312. The first and second catches 312a, 312b may be rectangular voids respectfully extending through the first and second docking members 302a, 302b. The hub 104 may be configured to selectively engage the first and second catches 312a, 312b to selectively retain the adapter 108 relative to the receiver 106 of the hub 104.

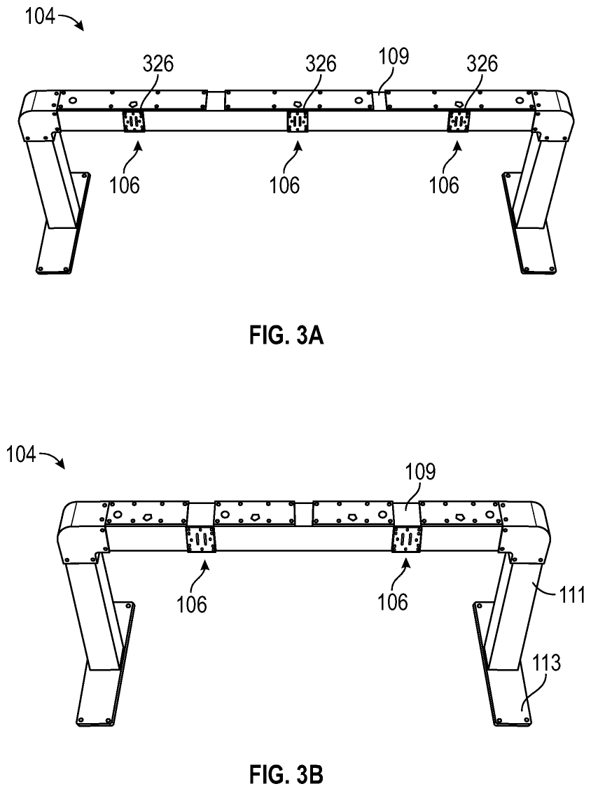

FIGS. 3A and 3B illustrate exemplary hubs 104. The hub may include a plurality of stations, each station including a receiver 106. Each receiver 106 is configured to engage with an adapter of an electric vehicle. In FIG. 3A, three receivers are provided. In FIG. 3B, two receivers are provided. A user control panel is provided associated with each receiver. The user control panels of the embodiment of FIG. 3A and the embodiment of FIG. 3B illustrate two sample control panels but alternative designs, options, and configurations are within the scope of the invention. The hubs may be bolted in place at a location or may be freestanding. The hubs may be directly grid connected or may be plugged into a standard wall outlet.

In some embodiments, the hub may include first and second vertically extending legs 111 and a main tube 109, also referred to as a horizontal bar, extending therebetween. Space may be provided below the main tube 109 to accommodate the body of an electric vehicle. In other embodiments, a single vertically extending leg may be provided with at least one horizontal bar extending therefrom. In an embodiment involving a single vertically extending leg, for example, one horizontal bar may be provided to provide an L configuration, two horizontal bars may be provided in line with one another to provide a T configuration, or four horizontal bars may be provided at right angles to one another. The exact configuration of the hub may be customized based on space available at a site for receiving the hub. Each leg 111 may terminate in a foot 113. The foot 113 may include one or more apertures for receiving a bolt to bolt the hub in place.

Each hub, and optionally each station of each hub, may include a nightlight illuminating port openings to indicate where an electric vehicle should be placed on the hub, via coupling of the adapter to the receiver. More specifically, the nightlight may illuminate all or a portion of the receptacles of a hub coupling mechanism.

Each station may include one or more light indicators 326 disposed on the hub 104 for providing visual indication regarding the status of the station. For example, the light indicator 326 may have distinct colors assigned for different operating conditions of the associated station receiver 106 of the hub 104 such as open, docked, charging, done charging, experiencing an error, etc. In some embodiments, a light indicator 326 may change colors, such as from green to yellow, or patterns, such as from solid to flashing, to signify that an electric vehicle 102 has been docked to its corresponding receiver 106.

In the embodiment of FIG. 3A, the light indicators each comprise a light provided adjacent the receiver 106. In the embodiment of FIG. 3B, the light indicators comprise a status light ring provided below or around the control panel. In other embodiments, the light indicators may be provided on the control panels.

In some embodiments, the hub may have a speaker system that can be used for communication with a user. The hub may audibly indicate when a port is locking or unlocking, when an error has occurred, how much charging time a user has purchased, and/or other information.

The hub may further be equipped with an alarm system. For example, the hub may have sensors for detecting when a port is being forced to unlock, shaking, or moving. The hub may generate an audible alarm upon detection of movement consistent with theft.

The hub has internal circuitry for supplying power to each receiver, or hub coupling mechanism, such that power may be drawn by an adapter, or vehicle coupling mechanism, and supplied to an associated electric vehicle.

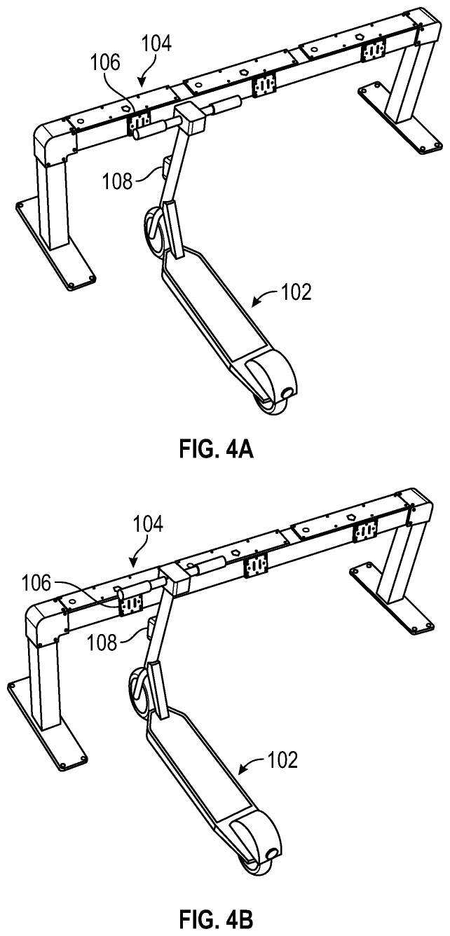

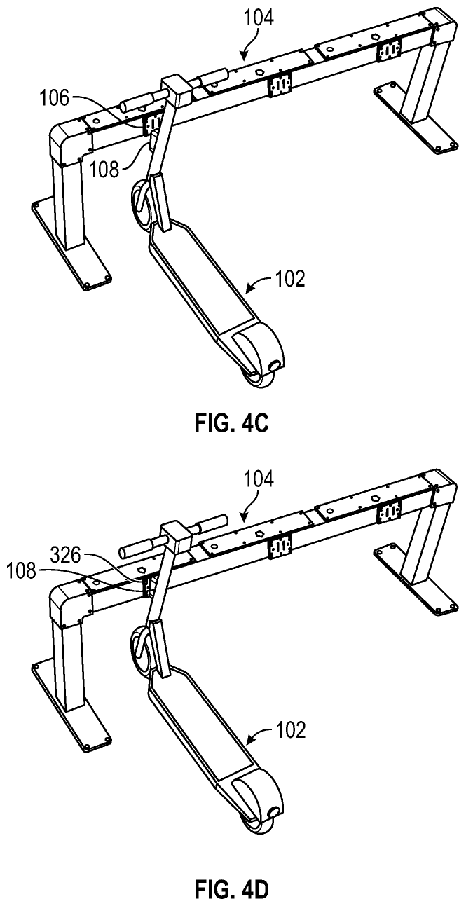

FIGS. 4A through 4D show a sequence of an electric vehicle 102 approaching a hub 104 and engaging a receiver of the hub to be charged. The electric vehicle 102 includes an adapter 108, or vehicle coupling mechanism. The adapter 108 includes docking members, also referred to as tangs, for interfacing with a receiver. The hub 104 includes a receiver 106, or hub coupling mechanism. The receiver 106 includes receptacles 308a, 308b. including an adapter 108 approaching a hub 104 including a receiver 106. FIGS. 4A and 4B illustrate the electric vehicle approaching the hub 102. FIG. 4C shows the adapter 108 engaging the receptacles 308a, 308b of the receiver 106. FIG. 4D shows the adapter 108 docked in the receiver 106 to retain the electric vehicle 102 to the hub 104.

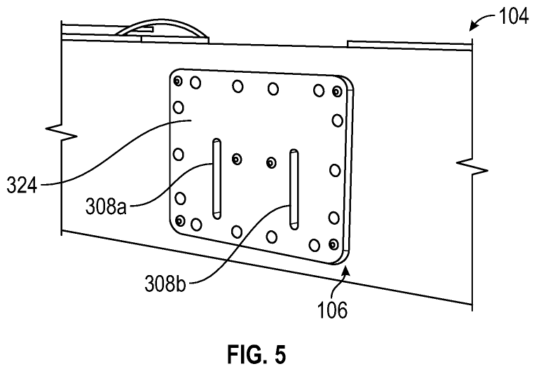

FIG. 5 illustrates a first embodiment of a hub coupling mechanism 106, referred to as a receiver. The receiver 106 includes one or more receptacles 308, also referred to as slots, corresponding to the one or more docking members of the adapter. In the embodiment shown, two receptacles 308a and 308b are shown. In other embodiments more or fewer receptacles may be provided. The receiver 106 may include an upper portion 304 and a lower portion 306, with the upper portion 304 and lower portion 306 together defining the receptacles. The docking members of the adapter are configured to respectively engage the receptacle to dock the electric vehicle to the hub to selectively retain the electric vehicle relative to the hub and to charge the batteries of the electric vehicle.

As shown, the receiver 106 of the hub 104 may further include a weather seal 324 coupled to the front of the receiver 106 to shield the receiver 106 from moisture and/or debris. In some configurations, a gasket (now shown) may be disposed between the weather seal 324, also referred to as a weather cover or a faceplate, and the hub 104 and/or the receiver 106. The components of the receiver 106 behind the weather seal 324 may be referred to as a port assembly.

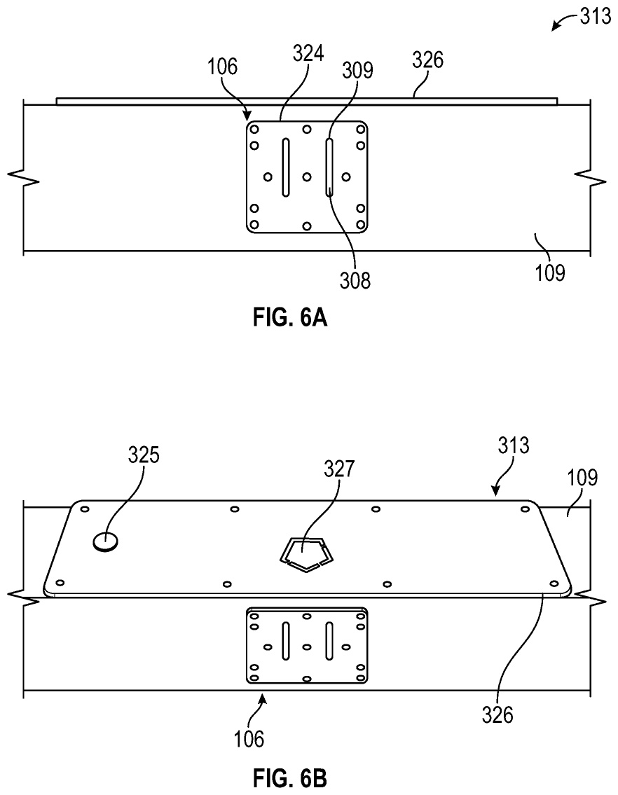

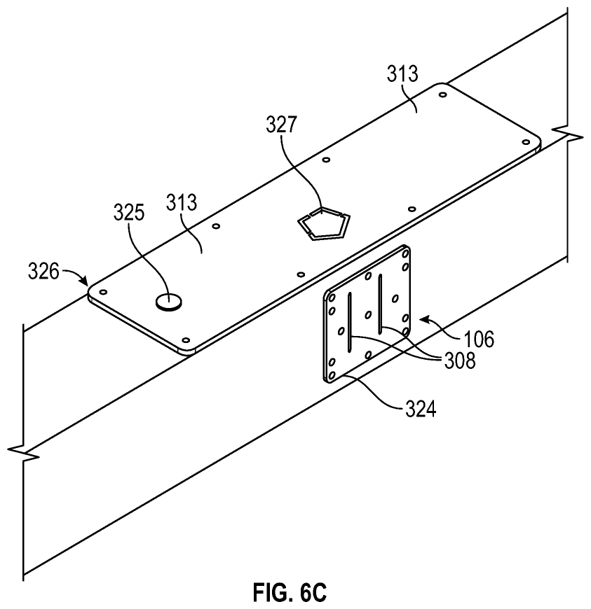

FIGS. 6A-6C illustrate a second embodiment of a receiver 106, or hub coupling mechanism. FIG. 6A illustrates illuminated receptacles for low light visibility. FIGS. 6B and 6C further illustrate a control panel associated with the receiver. The receiver 106, or hub coupling mechanism, includes receptacles/slots 308 for receiving docking members/tangs of the adapter, or vehicle coupling mechanism. The receptacles may have any suitable configuration so long as they correlate to the configuration of the docking members. Further, any number of receptacles may be used. In the embodiment shown, two receptacles are provided the receptacles comprise tang slots. FIG. 6A illustrates illuminated portion 309 of receptacles 308. In the embodiment shown, the illuminated portion 309 is provided at an upper portion of the receptacles 308. In other embodiments, all of or a different portion of the receptacles may be illuminated. A weather cover or faceplate 324 is provided over the internal circuitry of the receiver 106. The receptacles extend through the faceplate.

As shown in FIGS. 6B and 6C, the control panel 313, also referred to as a service panel, may include a push button 325 for unlocking the station, a port identification number 327, and a status light ring 326. The port identification number provides an identification of the station at which the electric vehicle is being charged. This may be associated with an app such that a user can access information about charging of the electric vehicle when they are separate from the electric vehicle. In some embodiments, the station may be unlocked by receipt of communication from a tag associated with the adapter on the vehicle or by user unlock via the micromobility charging app. A push button unlock feature may be particularly useful for unlocking a shared/rentable electric vehicle. The status light ring 326 may indicated status of the station such as open, docked, charging, done charging, or experiencing an error. In some embodiments, the status light ring 326 may comprise an RGB light ring.

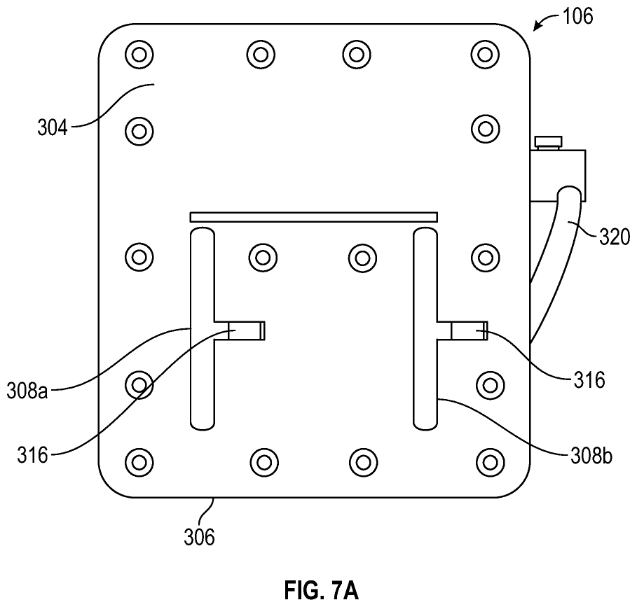

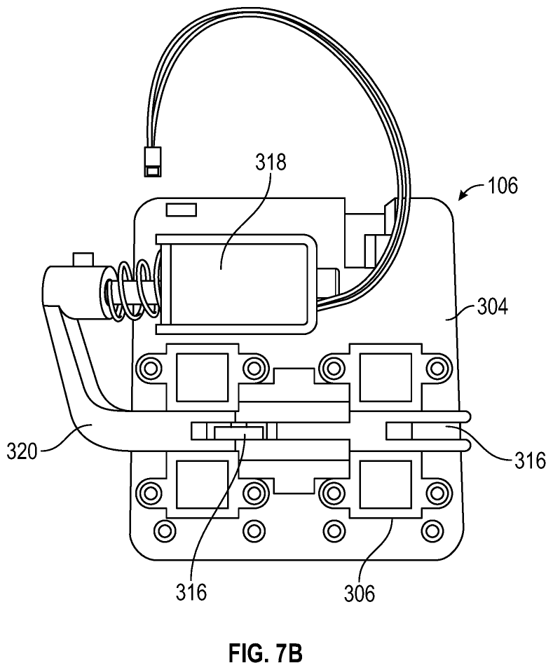

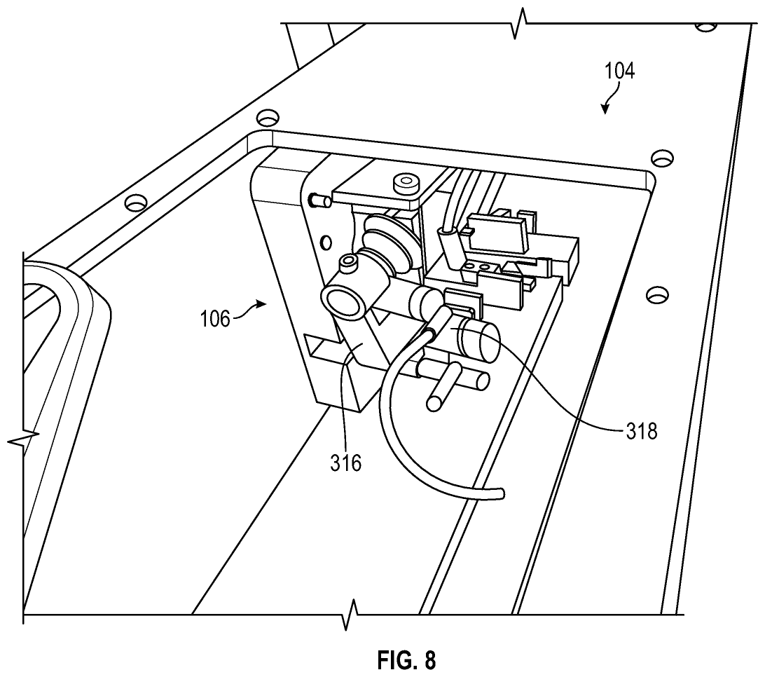

FIGS. 7A and 7B illustrate further detail of the receiver 106, also referred to as a hub coupling mechanism, in accordance with one embodiment. FIG. 8 illustrates a rear perspective view of the receiver 106 of FIGS. 7A and 7B as positioned within a hub 104. As shown, the receiver 106 may include an actuator 318 operatively attached to one or more latches 316 to move the one or more latches 316 between a locked configuration 316L and an unlocked configuration 316U. The actuator 318 may be any suitable device configured to move the latches 316, such as a solenoid. One or more intermediate members 320 may be arranged between the actuator 318 and the one or more catches 316 to translate the force generated by the actuator 318 to the catches 316. In some configurations, each locking assembly 314 may have its own corresponding actuator 318.

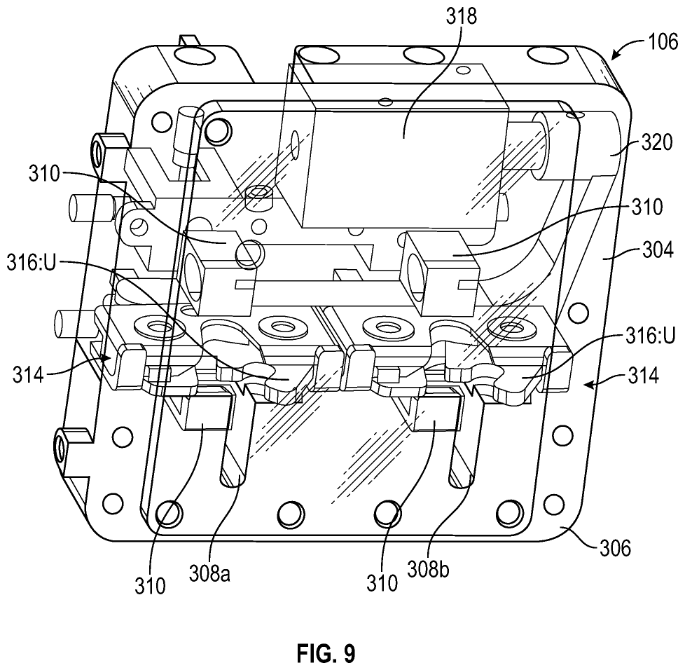

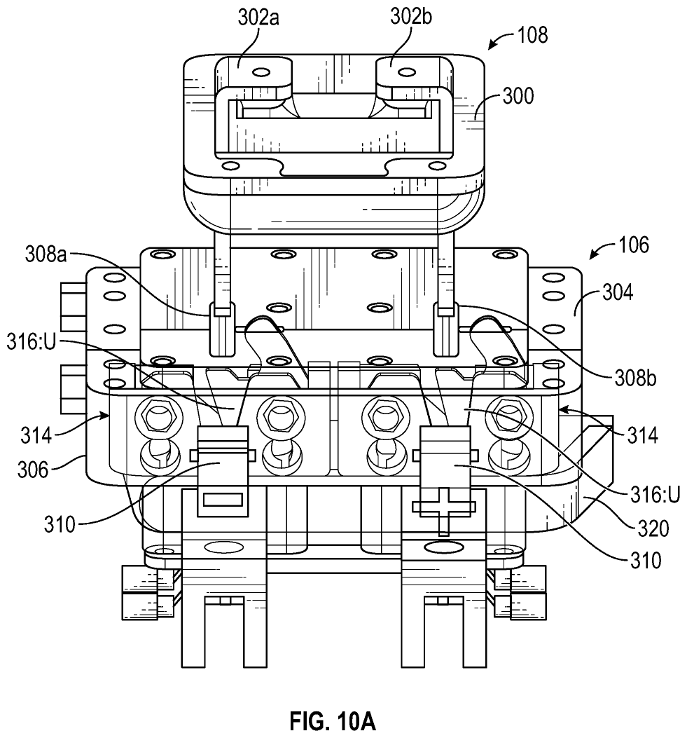

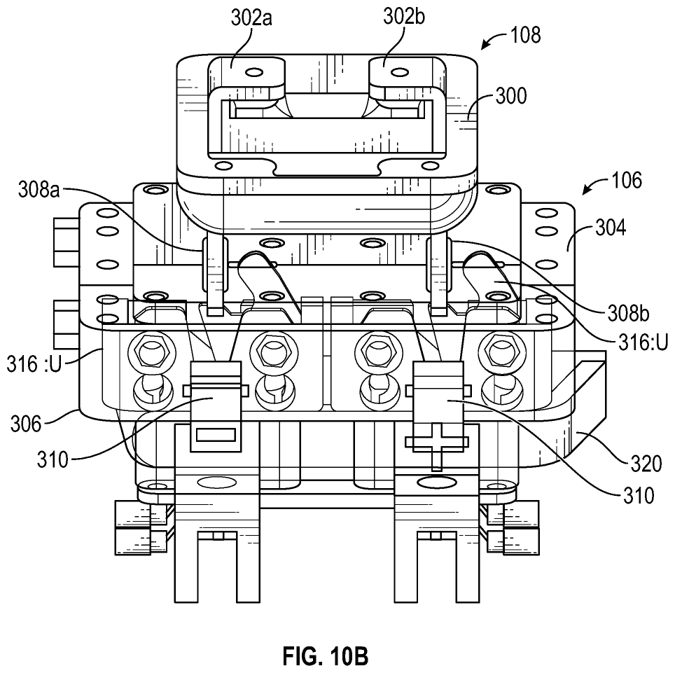

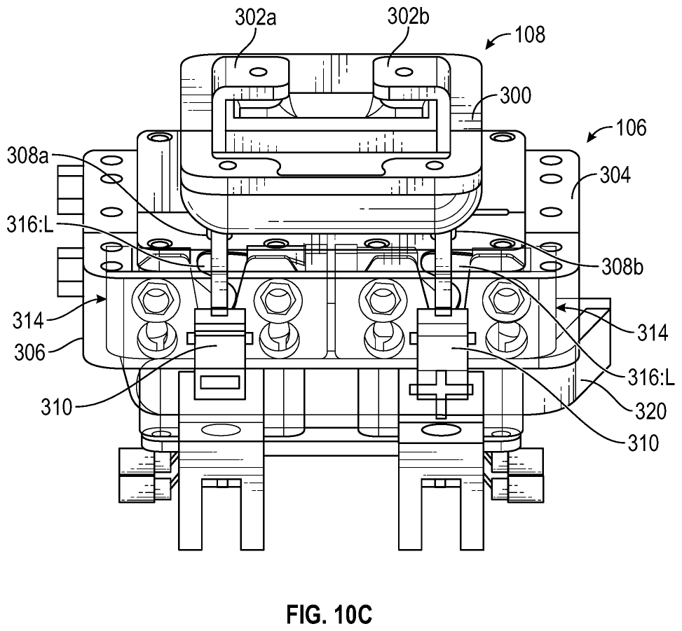

FIGS. 9 and 10A-10C illustrate further aspects of the receiver 106 shown in FIGS. 7A and 7B. The receiver 106, or hub coupling mechanism, may include electrical connectors that are in electrical communication with the electrical contacts 310 provided within the hub 104 to place the hub 104 in electrical communication with the adapter 108, or vehicle coupling mechanism, to charge the electric vehicle 102. FIGS. 10A-10C illustrate a sequence of the adapter engaging the hub to charge an electric vehicle and retain the adapter relative to the hub, in accordance with a first embodiment.

The electrical contacts 310 may be configured to abut the first and second docking members 302a, 302b when they are engaged with the first and second receptacle 308a, 308b. For example, the electrical contacts 310 may be biased toward the first and second receptacle 308a, 308b to ensure contact with the first and second docking members 302a, 302b when they are engaged with first and second receptacle 308a, 308b. Accordingly, when the first and second docking members 302a, 302b are engaged with the first and second receptacle 308a, 308b, the hub 104 is placed in electrical communication with the adapter 108 of the electric vehicle 102 to communicate with the electric vehicle 102 and/or charge the batteries of the electric vehicle 102.

As previously discussed, the receiver 106, or hub coupling mechanism, may include at least one locking assembly 314 for retaining at least one of the first and second docking members 302a, 302b within the first receptacle 308a and/or the second receptacle 308b, respectively, to limit movement of the adapter 108 relative to the receiver 106 of the hub 104. In the configuration shown, the receiver 106 includes two locking assemblies 314 to retain both the first and second docking members 302a, 302b relative to the first and second receptacles 308a, 308b, respectively. In one embodiment, each of the locking assemblies 314 includes a latch 316 configured to move between the locked position 316L and the unlocked position 316U. In the locked position 316L, the latch 316 is configured to engage one of the catches 312a, 312b to selectively retain its corresponding docking members 302a, 302b within their corresponding receptacles 308a, 308b. In the unlocked configuration 316L, the latch 316 is spaced from the catches 312a, 312b such that the docking members 302a, 302b may translate relative to their corresponding receptacles 308a, 308b.

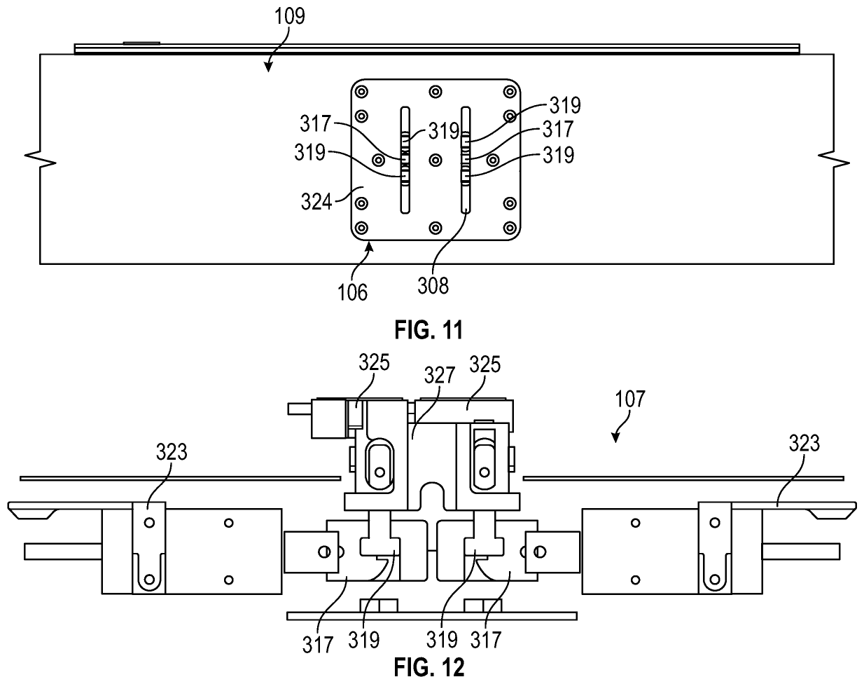

FIG. 11 illustrates a front view of a receiver 106, or hub coupling mechanism, in accordance with a second embodiment. As shown, the receiver 106 includes receptacles 308. Charging plungers 319 and locking lugs 317 are provided as part of a hub component assembly associated with the receiver 106. The charging plungers may be spring loaded and the locking lugs may be spring loaded. The receptacles may have a length longer than the height of docking members on the adapter to allow for vertical tolerances in the ground for if the surface is higher or lower than an anticipated flat surface. Such differential between receptacle and docking member sizing may allow for a tolerance of, for example, +/−10 mm

FIG. 12 illustrates a top view of a hub component assembly 107, in accordance with a second embodiment. As shown, the hub component assembly 107 includes a locking assembly, charging plungers 319, and induction sensors 325. The locking assembly includes the locking lugs 317, a solenoid lock body 321 supported by solenoid support brackets 323. FIG. 12 further illustrates a port back body 327. When an adapter is inserted into a receptacle, the charging plungers move backward towards the induction sensors. During insertion the locking lugs move out of the way until the adapter locks into the lugs, and are close enough to the sensors to start the charging authentication process. During this process the station scans the NFC tag with the vehicle identification number and charging profile. If this is accepted, charging is turned on to the charging plungers.

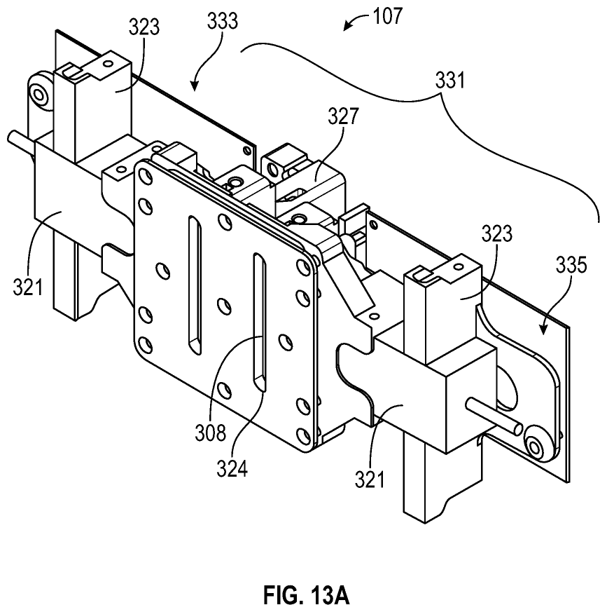

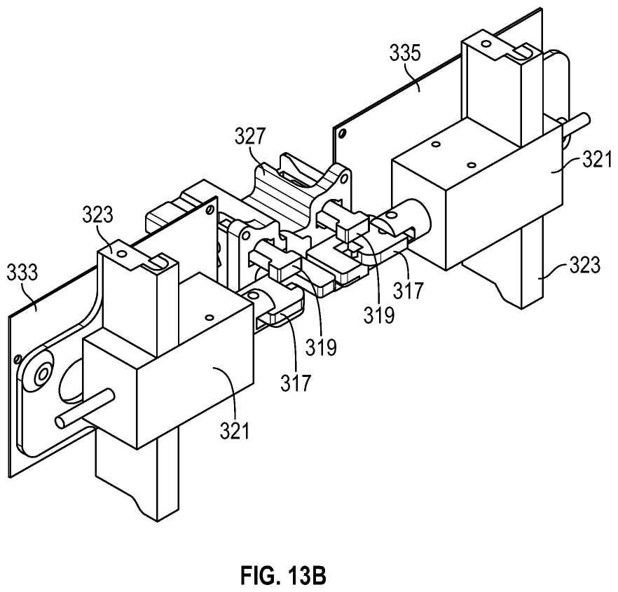

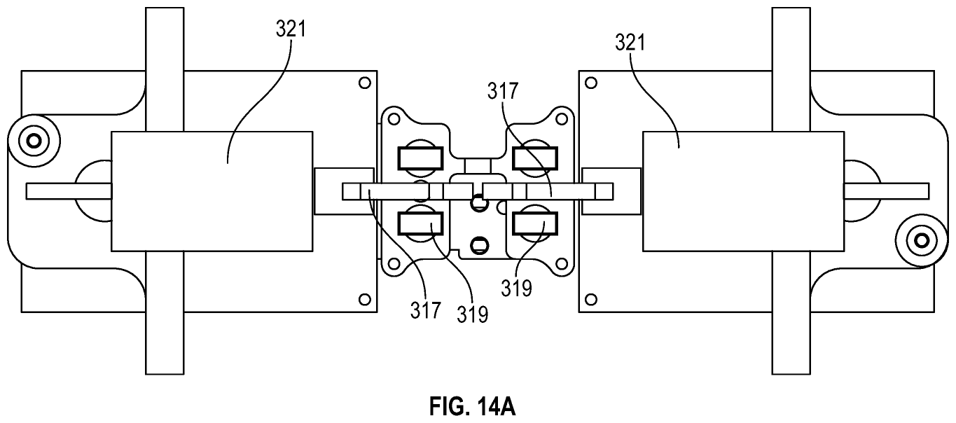

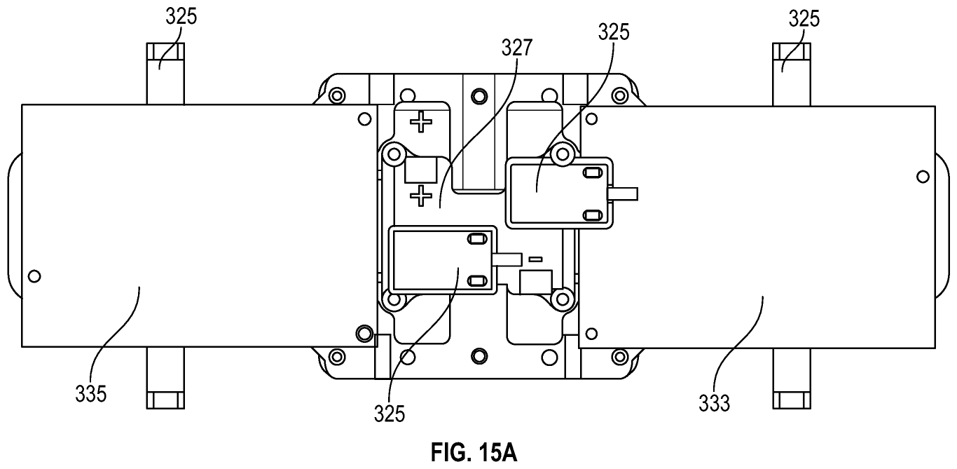

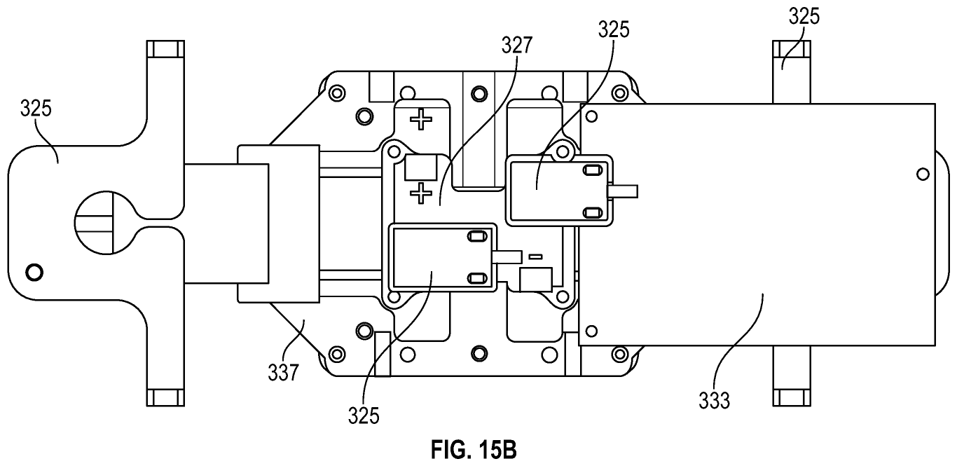

FIGS. 13A and 13B illustrate front perspective views of a hub component assembly 107. FIG. 13A illustrates the hub component assembly 107 with the weather cover 324 of the receiver of FIGS. 11 and 12 attached thereto. FIG. 13B illustrates the hub component assembly without the weather cover 107 or port main body to better illustrate the locking components. As shown, the hub component assembly 107 includes a port assembly 331. The port assembly includes a port controller board 333, a low power board 335, a port back body 327 and a port front body 337 (see FIG. 15B). Solenoid lock bodies 321 are provided forward of the power boards 333 and 335 and on either side of the receiver. The solenoid lock bodies 321 interface with locking lugs 317. The solenoid locks provide locking of the electric vehicle into the port for security. Receptacles or slots 308 through the weather cover 324 provide access to charging plungers 319. The port controller board 333 controls power for charging a docked electric vehicle. The lower power board 335 controls power for powering auxiliary components of the hub. In general, a single low power board 335 may be provided per hub while a port controller board 333 may be provided associated with each station.

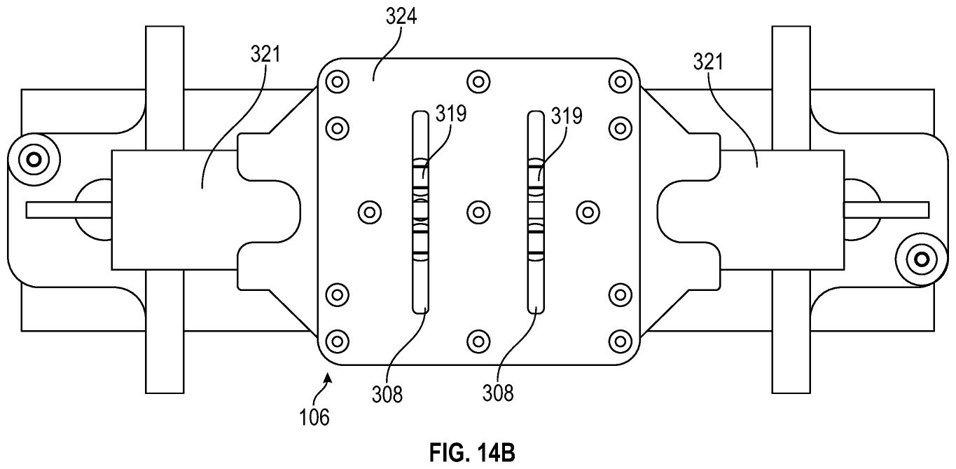

FIGS. 14A and 14B illustrate a front view of the hub component assembly 107 of FIGS. 13A and 13B. In these figures, a single port assembly and associated receiver is provided in the main tube of a hub. FIG. 14A illustrates the hub component assembly without the weather cover of the receiver attached. FIG. 14B illustrates the hub component assembly with the weather cover of the receiver attached.

FIG. 15A illustrates a rear view of the hub component assembly of FIGS. 13A, 13B, 14A, and 14B with a first port assembly in a main tube of a hub. FIG. 15A illustrates the induction sensors 325. The induction sensors check whether an electric vehicle is docked in the port.

FIG. 15B illustrates a rear view of the hub component assembly of FIGS. 13A, 13B, 14A, and 14B with a second port assembly in a main tube of a hub. A second port controller board is provided associated with the second port assembly. However, a second low power board is not provided because low power components of the second station are powered by the single low power board associated with the main tube of the hub.

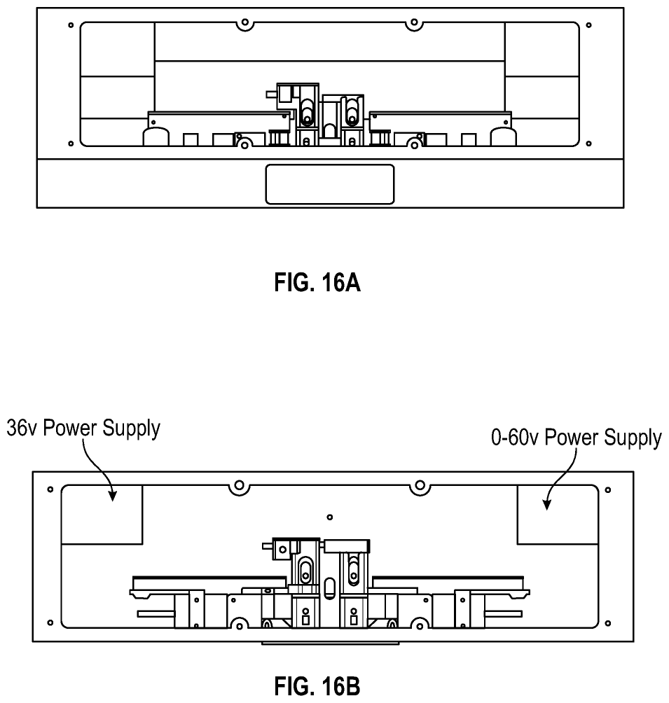

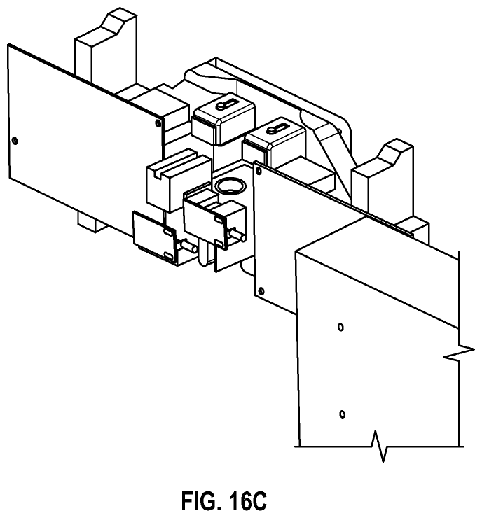

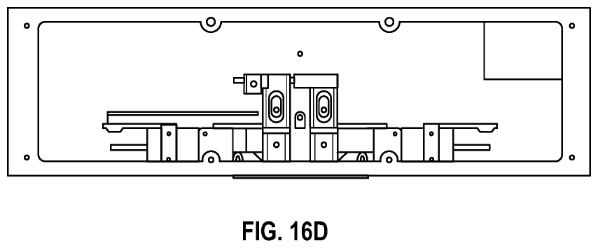

FIGS. 16A-16D illustrate a hub component assembly inside a main tube of a hub. Surrounding power supplies are shown. These may include, for example, two or more power sources may be provided: a first power source or low power source, such as a 36v power source, for auxiliary parts like lights, fans, circuit board power, solenoid actuation, and a second power source, such as a variable power source, for charging a vehicle. In general, a single 36v power supply may be provided in each main tube while a variable power supply may be provided associated with each station. The variable power supply may be a 0-60v.

It is to be appreciated that while a plurality of embodiments are disclosed, components or aspects of each embodiment may be readily interchanged with similar components or aspects of another embodiment.

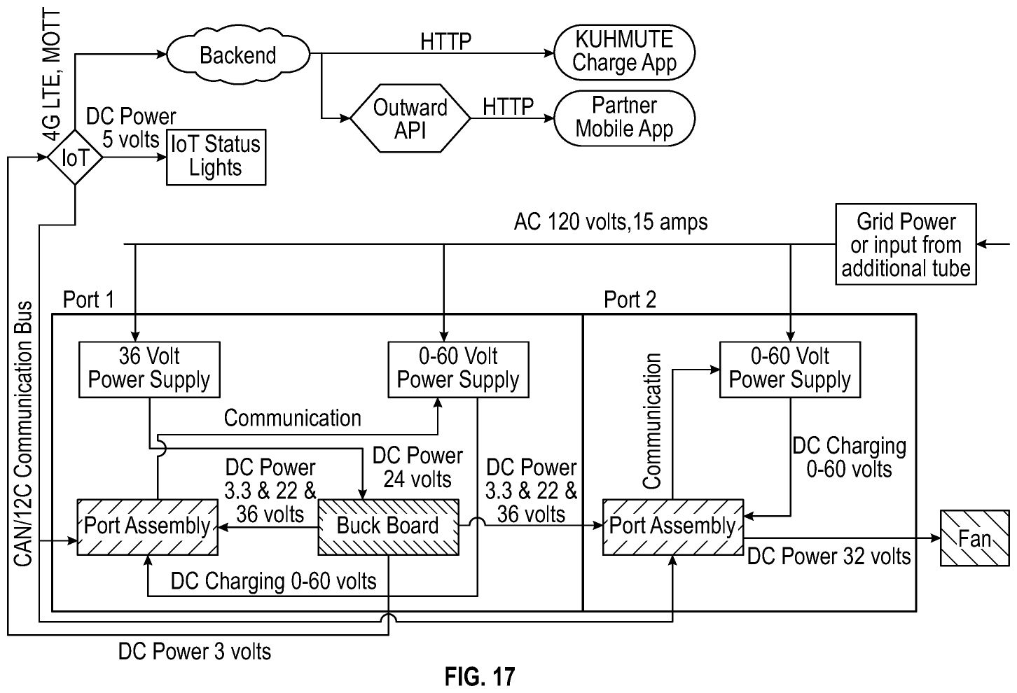

FIG. 17 illustrates a high level hub component diagram, in accordance with one embodiment. First and second port component boxes, Port 1 and Port 2, are shown. The first port component box includes a first Port 1 power supply, shown as a 36 volt power supply, and a second Port 1 power supply, shown as a 0-60 volt power supply, a Port 1 port assembly, and a lower power board. The second port component box includes a Port 2 power supply, shown as a 0-60 volt power supply, and a Port 2 port assembly. Each of the first port component box and the second port component box may be grid powered or may pull power from a separate hub. The power supplied to the first port component box and the second port component box may be AC 120 volt, 15 amps power. The connection to the grid may be via a direct connection, by plugging into a standard wall outlet, or using any other suitable connection. A fan may be associated with either or both of the first port component box and the second port component box.

The first port component box and the second port component box encapsulate the first and second ports within a main tube of the hub. Main tubes may be connected together to create larger continuous hubs for increased parking.

An IoT is provided and used to connect to, for example, a cellular network, to communicate with a backend system. Communication may include information about the status of each hub and the stations or ports within that hub. Status include, for example, electric vehicle parked, parking available, port down, charging enabled, charging disabled, supercharging enables, vehicle batter SOC (status of charge), and the like.

The hubs are in communication with a backend system. The backend system may be in communication with a micromobility charging network app and may include a partner mobile app. In some embodiments, the backend system may be in constant communication with the micromobility charging network app and/or the partner mobility app. The partner apps may be integrated over an outward API.

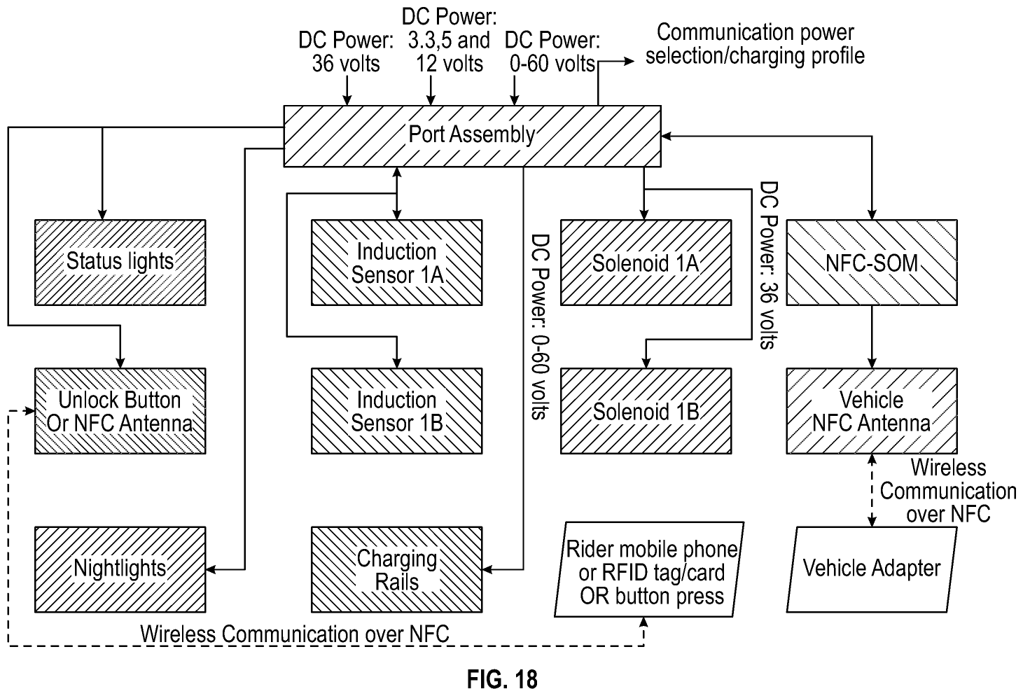

FIG. 18 illustrates a diagram of the port assembly, in accordance with one embodiment. The port assembly is the main interface between the hub and electric vehicles. The port assembly receives DC power form one or more sources and communicates power selection and/or charging profile to the back end. Power is provided to one or more charging rails of the hub.

A nightlight may be provided to illuminate port openings of a station in low light. The port assembly has status lights showing status of each station. The station may be unlocked via a push button or communication from a tag associated with the adapter on the electric vehicle.

Induction sensors check whether a vehicle is docked in the port of a station. When a vehicle is properly docked, solenoid locks may be actuated to lock the vehicle into the port for security. The charging rail(s) provide physical connection to the electric vehicle for charging.

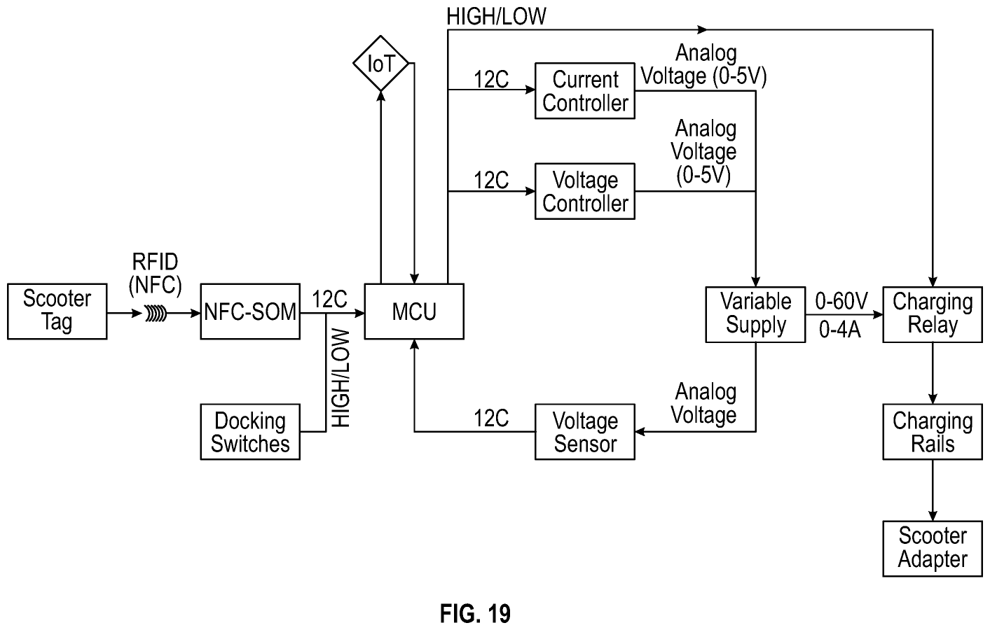

FIG. 19 illustrates a process flow of a variable charging selection process, in accordance with one embodiment. While a scooter is specifically referred to in FIG. 19, it is to be appreciated that any type of micromobility electric vehicle may use the variable charging selection process. An electric vehicle arrives at a hub and triggers the docking switches to signify a vehicle is docked. Information about the vehicle charging profile is sent to the backend. This may be done by a tag associated with the vehicle, such as on the adapter. The tag may be, for example, an RFID tag or an NFC tag. Alternatively, the profile may be sent by the user using the micromobility charging network app. A user is able to end use of a rental vehicle using an associated charging app. A microcontroller unit (MCU) sets constant current and constant voltage levels of the variable supply. The MCU may continuously check the variable supply output. Once the variable supply is set, the MCU switches the charging relay and allows current flow to the charging rail(s) and to the adapter to begin charging.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A system for charging electric vehicles, the system comprising:
a vehicle coupling mechanism associated with a vehicle, the vehicle coupling mechanism including a docking member;
a hub, the hub comprising:
a main tube;
a station, the station comprising:
a hub coupling mechanism comprising a receptacle for receiving the docking member, the coupling mechanism being provided on the main tube and being accessible by a user;
a hub component assembly comprising a locking assembly, charging plungers, and induction sensors, wherein when the receptacle receives the docking member, the charging plungers are moved towards the induction sensors, the locking assembly locks the vehicle in place, and the induction sensors sense a vehicle locked in the station and activate the hub to begin charging the vehicle.

2. The system of claim 1, wherein the at least one receptacle is a slot and wherein the at least one docking mechanism is a tang.

3. The system of claim 1, wherein the hub component assembly further comprises a port assembly, wherein the port assembly includes a port controller board and a low power board.

4. The system of claim 3, wherein the port controller board includes 36v power supply and the low power board includes a variable power supply.

5. The system of claim 1, wherein when the induction sensors sense a vehicle locked in the station, the induction sensors start a charging authentication process and activate the hub to being charging the vehicle upon a positive authentication process.

6. The system of claim 5, wherein the vehicle coupling mechanism further comprises a tag having an identification number associated therewith and wherein the charging authentication process involves scanning the tag.

7. The system of claim 1, wherein the locking assembly includes a solenoid lock body and a locking lug wherein insertion of the docking member into the receptacle moves the locking lug towards the induction sensor.

8. The system of claim 1, further comprising a control panel associated with the station, wherein the control panel includes a push button for unlocking the station, a port identification number, and a status light ring, wherein the status light ring provides a visual indication of a status of the station.

9. The system of claim 8, further comprising a second station and a second control panel associated with the second station.

10. The system of claim 1, further comprising a light source for illuminating a portion of the at least one receptacle.

11. The system of claim 1, wherein the vehicle is a micro-mobility electric vehicle.

12. A system for charging electric vehicles, the system comprising:
a vehicle coupling mechanism associated with a vehicle, the vehicle coupling mechanism including a docking member;
a hub, the hub comprising:
a main tube;
at least two stations, each station comprising:
a hub coupling mechanism comprising a receptacle for receiving the docking member, the coupling mechanism being provided on the main tube and being accessible by a user;
a hub component assembly comprising a locking assembly, charging plungers, and induction sensors, wherein when the receptacle receives the docking member, the charging plungers are moved towards the induction sensors, the locking assembly locks the vehicle in place, and the induction sensors sense a vehicle locked in the station and activate the hub to begin charging the vehicle;
wherein the hub component assembly further comprises a port controller board for providing power to the station.

13. The system of claim 12, the hub further comprising a single low power board associated with all of the at least two stations for powering auxiliary components.

14. The system of claim 13, wherein the port controller board includes 36v power supply and the low power board includes a variable power supply.

15. The system of claim 12, wherein the at least one receptacle is a slot and wherein the at least one docking mechanism is a tang.

16. The system of claim 12, wherein when the induction sensors sense a vehicle locked in the station, the induction sensors start a charging authentication process and activate the hub to being charging the vehicle at the station upon a positive authentication process.

17. The system of claim 16, wherein the vehicle coupling mechanism further comprises a tag having an identification number associated therewith and wherein the charging authentication process involves scanning the tag.

18. The system of claim 1, wherein the locking assembly includes a solenoid lock body and a locking lug wherein insertion of the docking member into the receptacle moves the locking lug towards the induction sensor.

19. The system of claim 1, further comprising a control panel associated with the station, wherein the control panel includes a push button for unlocking the station, a port identification number, and a status light ring, wherein the status light ring provides a visual indication of a status of the station.

20. The system of claim 1, wherein the vehicle is a micro-mobility electric vehicle.
